(19) United States
(12) Patent Application Publication
(10) Pub. No.: US 2010/0057830 A1
(43) Pub. Date: Mar. 4, 2010

(54) Controlling Client-Server Communications

(75) Inventor: Jari Aarno Tapani Takala, Espoo (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/198,324

(22) Filed: Aug. 26, 2008

(51) Int. Cl. G06F 15/16

(52) U.S. Cl. 709/203

(57) ABSTRACT

Content requests and other communications from a client to a server may be filtered and processed by a proxy. The proxy may comprise a client-side component that determines whether the content request should be modified. The determination may be made based at least in part on predefined rules, for example. In one or more arrangements, the proxy may be part of a client device such as a mobile communication device. A content request may be modified to include additional information to obtain more tailored or customized content. Alternatively or additionally, a proxy may block content that is deemed to be inappropriate or unsuitable. Further, a proxy may add content to or remove content from a content item.

Some aspects of the invention generally relate to controlling client-server communications.

### BACKGROUND

Client devices such as mobile communication devices may often use various applications to transmit and receive data from servers. Generally, such client-server communication, including the addition or removal of parameters and data therefrom, is controlled by network operators or service providers.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some aspects of the present disclosure relate to the use of a proxy to control content requests and transmissions between a server and a client. In one arrangement, a proxy may evaluate and modify content requests to add or remove information to control what content is received. For example, a proxy may add geographic location or demographic information in an advertisement request to obtain more relevant advertisements. The proxy may further modify content based on various factors including size limitations, device capabilities, content rating restrictions, user preferences, environmental information (e.g., temperature, precipitation, noise level etc.), user data (e.g., heartbeat rate) and the like. According to one or more aspects, the proxy may further add content to a content item if, for example, a content item does not have any or enough advertisements.

According to other aspects, a proxy may block content if the content is deemed inappropriate for the device or user. Alternatively or additionally, the proxy may also redirect a content request if the original request includes an invalid source identifier. Content requests might also be redirected if the original content request is directed to an untrusted, unreliable or incompatible source.

According to yet other aspects, a proxy may be an internal component of a client device or may be an external system, device or component on the client-side.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of an example communication network in which one or more embodiments may be implemented.

FIG. 2 illustrates a block diagram of an example communication device according to one or more aspects described herein.

FIG. 3 illustrates an example network environment in which content transfers are facilitated by a proxy according to one or more aspects described herein.

FIG. 4 is a flowchart illustrating an example method for customizing content according to one or more aspects described herein.

FIGS. 5A and 5B illustrate example network data flows for processing a content page request according to one or more aspects described herein.

FIG. 6 illustrates an example data structure for defining proxy actions according to one or more aspects described herein.

FIG. 7 is a flowchart illustrating an example method for adding supplemental content to a content item in accordance with one or more aspects described herein.

FIGS. 8A and 8B illustrate examples of a pre-processing web page and a post-processing web page, respectively, according to one or more aspects described herein.

FIG. 9 illustrates a proxy apparatus and components thereof for controlling content transmission according to one or more aspects described herein.

FIG. 10 illustrates a communication diagram in which a content request is redirected to a requesting device according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

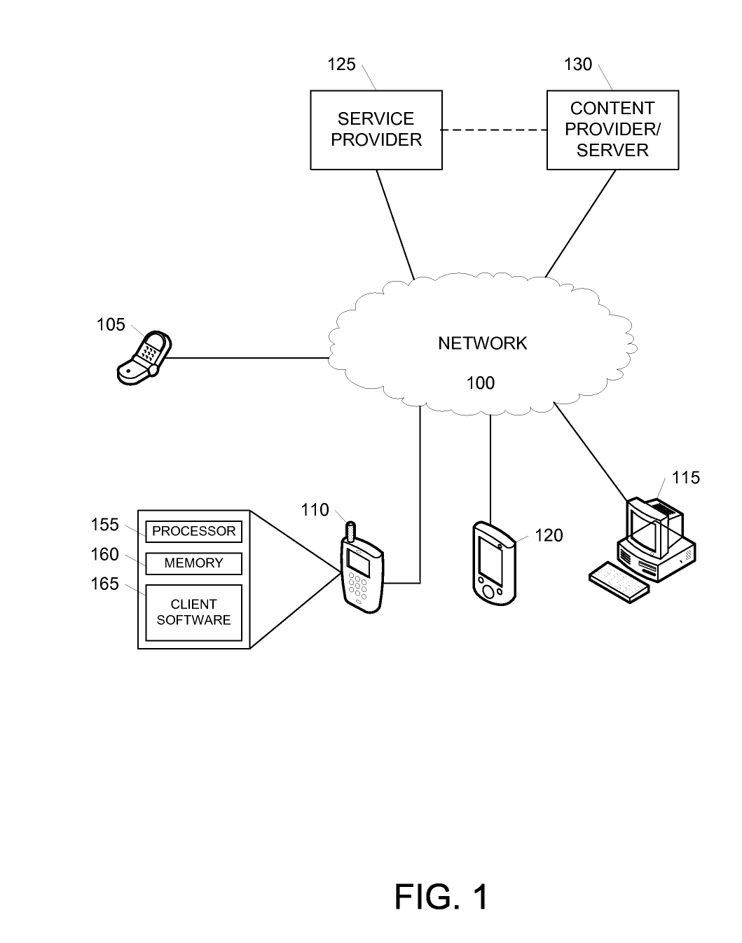

FIG. 1 illustrates an example communication network through which various inventive principles may be practiced. A number of computers and devices including mobile communication device 105, mobile phone 110, personal digital assistant (PDA) or mobile computer 120, personal computer (PC) 115, service provider 125 and content provider 130 may communicate with one another and with other devices through network 100. Network 100 may include wired and wireless connections and network elements, and connections over the network may include permanent or temporary connections. Communication through network 100 is not limited to the illustrated devices and may include additional mobile or fixed devices such as a video storage system, an audio/video player, a digital camera/camcorder, a positioning device such as a GPS (Global Positioning System) device or satellite, a television, an audio/video player, a radio broadcasting receiver, a set-top box (STB), a digital video recorder, remote control devices and any combination thereof

Although shown as a single network in FIG. 1 for simplicity, network 100 may include multiple networks that are interlinked so as to provide internetworked communications. Such networks may include one or more private or public packet-switched networks (e.g., the Internet), one or more private or public circuit-switched networks (e.g., a public switched telephone network), a cellular network configured to facilitate communications to and from mobile communication devices 105 and 110 (e.g., through use of base stations, mobile switching centers, etc.), a short or medium range wireless communication connection (e.g., Bluetooth®, ultra wideband (UWB), infrared, WiBree, wireless local area network (WLAN) according to one or more versions of Institute of Electrical and Electronics Engineers (IEEE) standard no. 802.11), or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access (e.g., a wireless service provider), client software 165 may include instructions for access and communication through the cellular network. Client software 165 may be stored in computer-readable memory 160 such as read only or random access memory in device 110 and may include instructions that cause one or more components (e.g., processor 155, a transceiver, and a display) of device 110 to perform various functions and methods including those described herein.

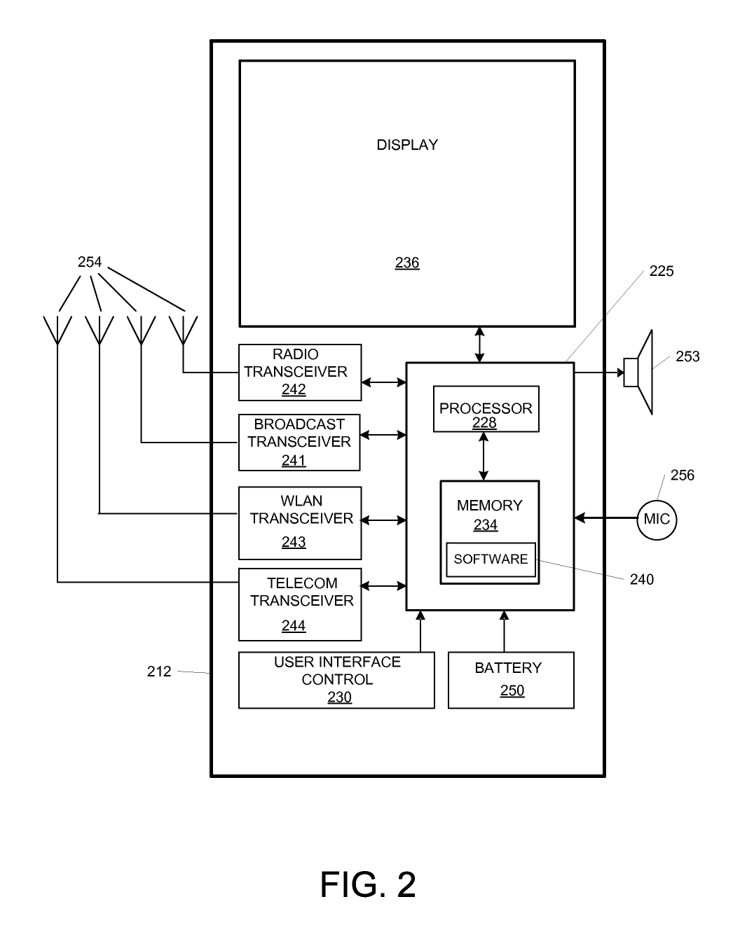

FIG. 2 illustrates an example computing device such as mobile device 212 that may be used in network 100 of FIG. 1. Mobile device 212 may include a controller 225 connected to a user interface control 230, display 236 and other elements as illustrated. Controller 225 may include one or more processors 228 and memory 234 storing software 240. Mobile device 212 may also include a battery 250, speaker 253 and antenna 254. User interface control 230 may include controllers or adapters configured to receive input from or provide output to a keypad, touch screen, voice interface (e.g. via microphone 256), function keys, joystick, data glove, mouse and the like.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like.

Mobile device 212 or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast transceiver 241. Other digital transmission formats may alternatively be used to deliver content and information of availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components.

Although the above description of FIG. 2 generally relates to a mobile device, other devices or systems may include the same or similar components and perform the same or similar functions and methods. For example, a stationary computer such as PC 115 (FIG. 1) may include the components described above and may be configured to perform the same or similar functions as mobile device 212 and its components.

Client devices such as mobile device 212 and PC 115 are often configured to execute various applications such as web browsers, on-line games, network applications and the like. The applications generally transmit requests for data and other content to servers through various types of networks. However, such applications are typically unaware of attributes or other characteristics of the client device or a user associated with the client device. For example, applications might not know a location of the client device, device or application usage characteristics of a user or profile information of a user. Thus, an application might not be able to tailor content based on information about the client device or user. In one example, a web page may include advertising content. In order to maximize the advertising opportunity, it would be helpful to have user or client information so that a retrieved advertisement is more particularly tailored to the user or client.

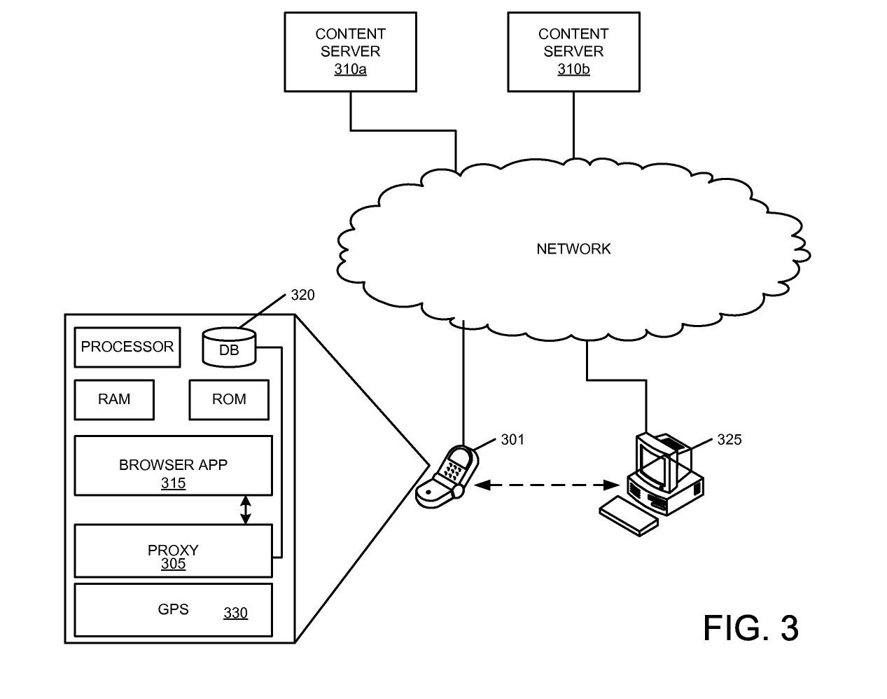

FIG. 3 illustrates a network in which a client device 301 may use a local proxy 305 to control content requested and received from one or more content servers 310. As illustrated, client device 301 is configured to run a browser application 315 that provides display and other rendering capabilities for various types of content. Content requests of application 315 may be intercepted or otherwise received by proxy 305 prior to being sent to content server 310. Proxy 305 may be configured to determine whether a content request or received content should be modified by, for example, adding request parameters, removing information from the request, adding content to a content item, blocking content and the like. Proxy 305 has access to a database 320 that is configured to store various types of data such as client location information, user profile and preference information, device settings, and the like, and thus may use such information to modify content requests. Client location information may be determined using various devices including GPS module 325. Once proxy 305 has determined whether to modify the content request or content item and, if necessary, modified the content request or content item, proxy 305 may transmit the content or content request to the appropriate party (e.g., proxy 305 may send received content to browser application 315 while sending content requests to server 310). Content server 310 may be configured to provide a variety of types of content including advertisements, music, video, text, free content, pay content and/or combinations thereof.

Although illustrated as a part of client device 301, proxy 305 may be separate from device 301. For instance, proxy 305 may be a separate client-side device that operates in conjunction with client device 301. In one example, proxy 305 may reside on PC 325 to which client device 301 is connected. In another example, proxy 305 may reside on a local network access device (e.g., a router) through which client device 301 is accessing a network.

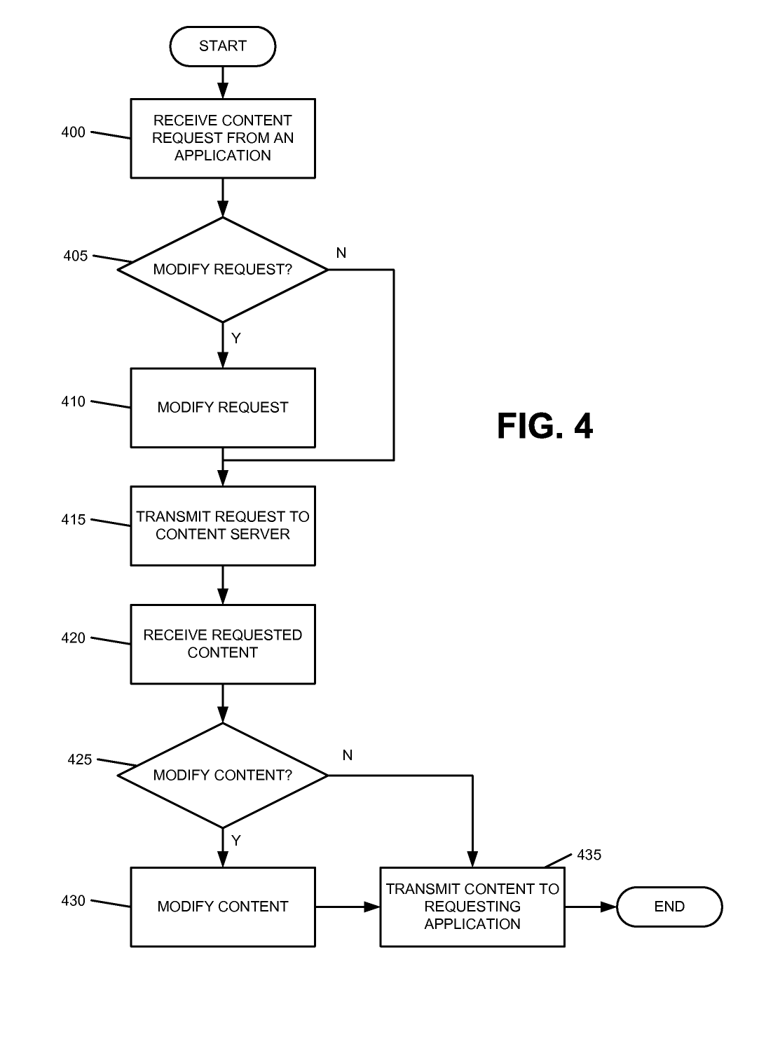

FIG. 4 illustrates an example method for controlling the type of content received in response to a content request. In step 400, a proxy may receive a content request from an application running on a client device (e.g., mobile device 212 of FIG. 2). The content request may include an identifier such as a uniform resource identifier (URI) that identifies the content source. The content request may further include one or more parameters specifying information such as a language preferred by the requesting device, a renderable/displayable size limit, browser type and the like. For example, in hypertext markup language (HTML) environments, parameters may be specified in the header of a uniform resource locator (URL)-based content request.

Upon receiving the content request and prior to the content request being transmitted to a content server, the proxy may determine whether to modify the request in step 405. The determination may be made in a variety of manners and based on various considerations including a type of content being requested, the type or identity of the content source, whether current parameters in the content request or identifier matches store client or user information and/or combinations thereof. In one example, a request for advertising content may result in more tailored or relevant advertisements if geographic location and user demographic information were included in the request. In another example, movie or game content being requested may need to be filtered based on an age of the user. Alternatively or additionally, certain content may be blocked entirely. For example, content from adult sites (18+) may be blocked in their entirety. Actions for various content sources may be predefined and stored in a database as discussed herein in further detail.

If the content request is to be modified, the proxy may modify the content request as appropriate in step 410. For example, if additional information or parameters are to be specified, the additional information may be retrieved and added to the content request. For example, a client's location may be specified by adding “X-location: 123/234” to an HTML content request header. Information and parameters may be retrieved from a database (e.g., database 320 of FIG. 3), other components of the client (e.g., GPS device 330, or a GPS module in the device) or devices, components or systems external to the client. Alternatively or additionally, if information is to be removed from the content request (e.g., if a default parameter is inconsistent with client or user specifications or to protect user privacy) the proxy may remove such information or parameters from the content request. For example, if the content request includes a parameter indicating eligibility to receive adult content by default, the proxy may remove such a parameter if the user is determined to be a minor. In another example, a content source may be modified if the proxy determines that the identifier specified is not a valid location or site. The proxy may replace the invalid identifier with a valid identifier. A proxy may determine whether a source identifier is valid or not, for example, by pinging the source prior to transmitting the request. A valid identifier may be determined or identified, for example, by correcting spelling errors or searching a list of commonly incorrectly entered identifiers. If, however, it is determined that no modifications are needed to the content request, the proxy may submit the content request as-is (e.g., without addition or deletion of information or parameters).

In step 415, the proxy may transmit the content request to a content server or source identified in the request. In response to the request, the proxy may receive or intercept the requested content in step 420. Upon receiving the requested content, the proxy may determine whether the content needs to be modified in step 425. For example, the proxy may modify the content based on size limitations, content rating restrictions, device capabilities and the like. In step 430, the proxy may modify the content and, in step 435, transmit the modified content to a requesting application if modification is deemed appropriate. Alternatively, if modification is not needed, the proxy may transmit the received content to a requesting application without changes in step 435. In yet another alternative embodiment, if content is to be blocked, the content request may be deleted or not transmitted to the content server.

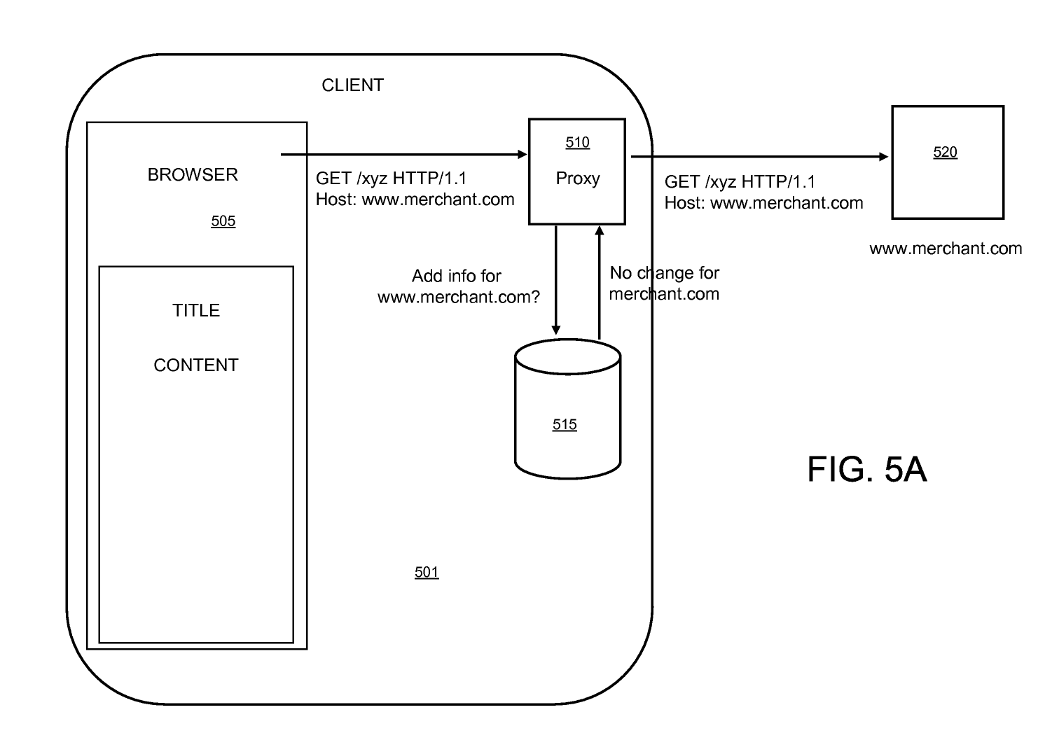

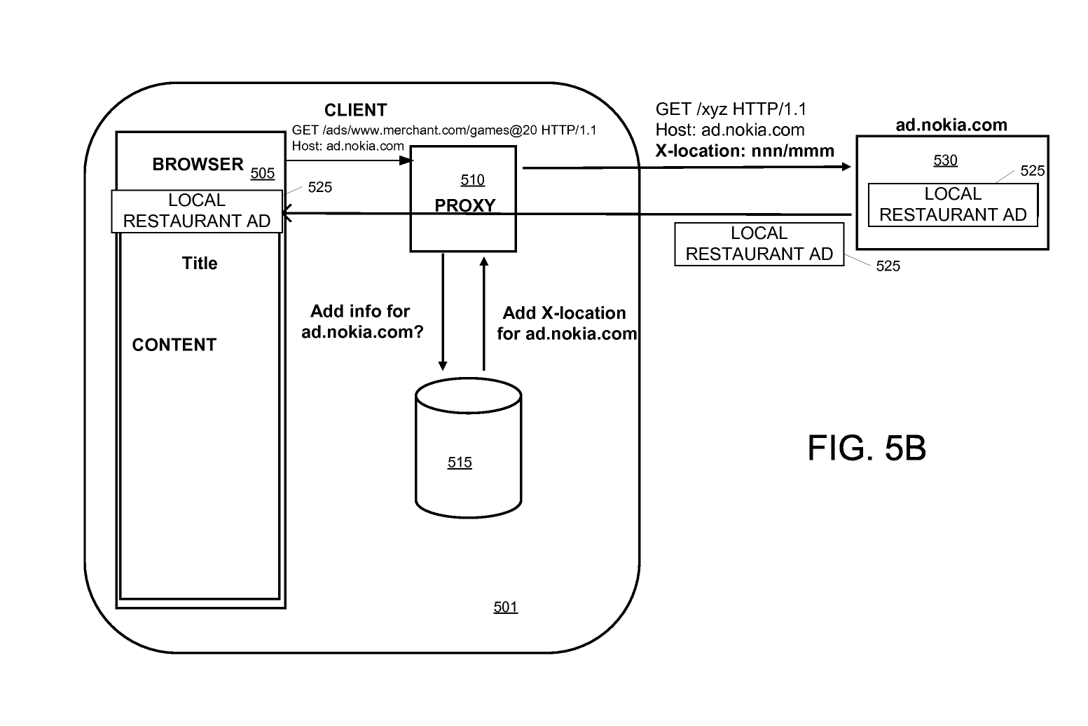

The above described method for tailoring and customizing content may be used for stand-alone content items as well as for embedded content (e.g., content included in other content). For example, a web page may include multiple embedded advertisements, each of which may be retrieved separately and subsequently combined with the underlying web page. In such instances, the proxy may tailor the underlying page and the advertisements using the methods and features described herein. FIGS. 5A and 5B illustrate a network communication flow for retrieving browser content and an advertisement included in the browser content. FIG. 5A, for example, illustrates client device 501 running browser 505 and including a proxy 510 and a database 515. Proxy 510 intercepts content requests such as a request from browser 505 for content from www.merchant.com. Proxy 510 determines whether the content request should be modified (e.g., by querying database 515) and subsequently transmits the request to the content server 520. Content server 520 responds with the requested content which includes an embedded advertisement 525 (FIG. 5B). Proxy 510 may then transmit the requested content to browser 505 which may render the received portion of the content upon receipt. Alternatively, browser 505 may wait for the entire content item including any embedded content such as advertisements prior to rendering.

Referring to FIG. 5B, because the requested content includes an advertisement 525, proxy 510 may receive a subsequent request from browser 505 requesting the embedded advertisement 525. Proxy 510 may again determine whether the request should be modified (e.g., according to the features of FIG. 4) and subsequently transmit the advertisement request to an advertisement server 530. For example, the content request may be modified to indicate demographic, geographic, preference information and the like. Alternatively or additionally, proxy 510 may independently generate and transmit a request for the embedded advertisement 525 upon evaluating the received content for embedded information. In response, proxy 510 may receive an advertisement, e.g., advertisement 525, meeting the specified parameters and transmit the advertisement 525 to browser 505 for incorporation with the underlying content.

From an application's perspective (e.g., browser 505), the interaction and communication with the proxy (e.g., proxy 510) may be transparent. That is, the application might not be aware of the proxy's existence and functionality. Thus, applications or other components might not need to be configured to operate specifically with the proxy.

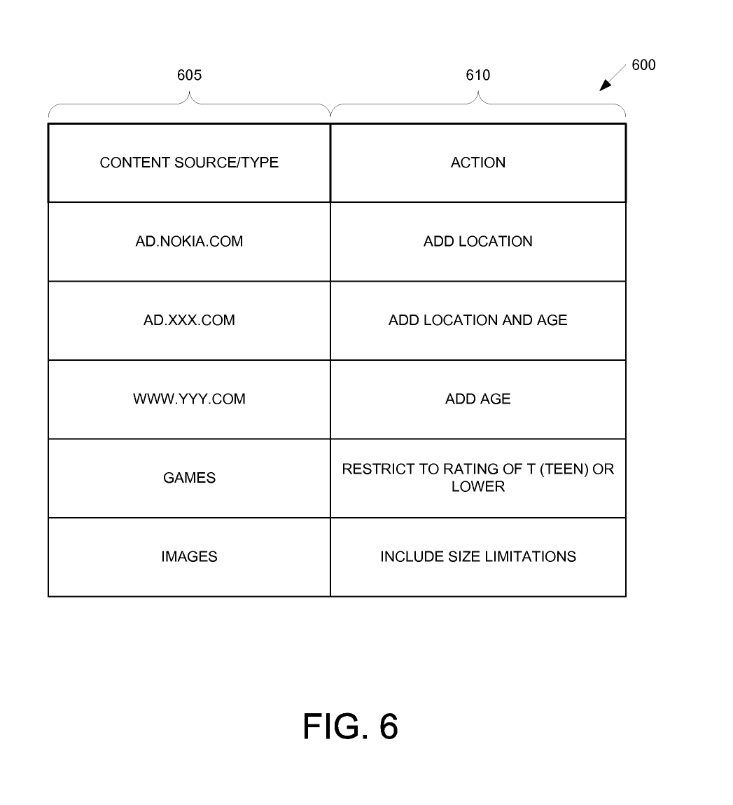

FIG. 6 illustrates an example data structure for defining and storing particular actions for particular content or content sources. The list 600 includes a list of URLs 605 and a corresponding list of actions 610. A proxy may determine whether to add or remove information from a content request, block, add or edit content or take other actions based at least in part on the content source. For content requested from ad.nokia.com, for example, a location parameter may be added to specify the location of the user or client device. In another example, content requested from a site such as spam.com may be blocked. List 600 may be stored in a database such as database 520 of FIG. 5 as a look-up table or in other formats. Further, list 600 may specify that any requests for content from an invalid site may be redirected to one or more specified valid sites. Thus, advertisement requests from invalid advertisement servers may be automatically redirected to a valid ad server such as ad.nokia.com or the like.

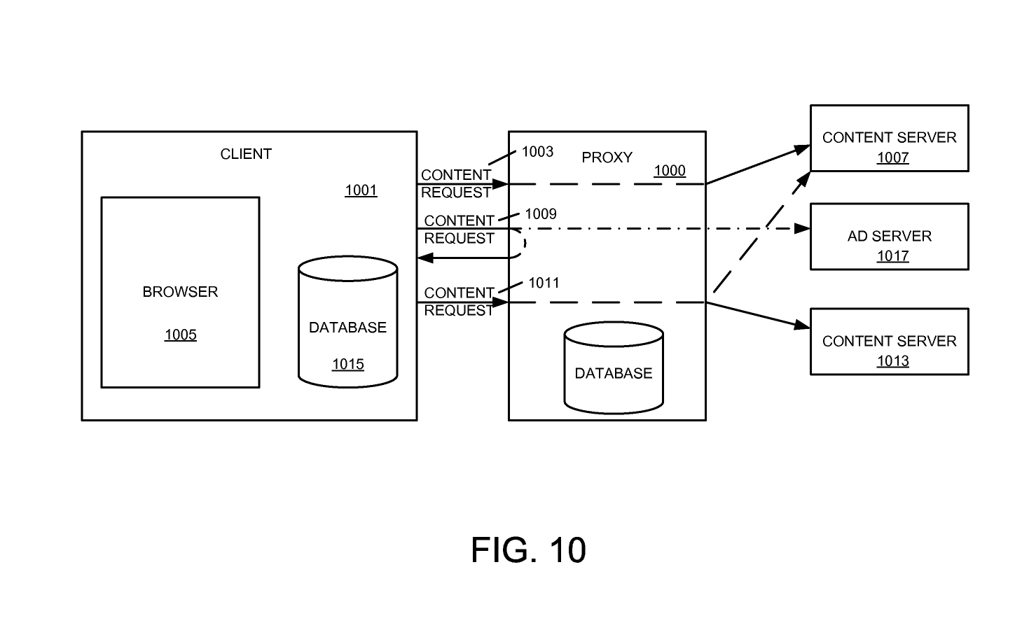

For example, FIG. 10 illustrates a scenario in which a first content request 1003 from a browser 1005 in device 1001 is directed to a server 1007 corresponding to the indicated address, e.g., www.website.com, while a second content request 1009 for an advertisement from ad.adserver.com is redirected by proxy 1000 to the requesting device 1001 or a storage area thereof (e.g., database 1015). The second content request 1009 may be redirected to reduce network traffic and delays in the event ads are available (e.g., stored) locally on device 1001. In another example, a third content request 1011 may be specified for server 1007, but is redirected to content server 1013. The redirection of the third content request 1011 may be a result of content rating restrictions, size limitations, subject matter rules and the like.

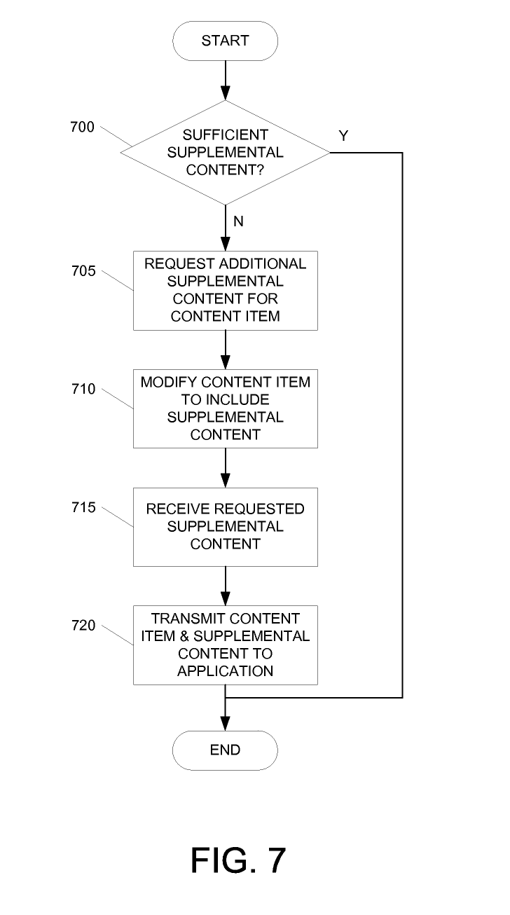

According to some aspects, a proxy may further request and add content not specified in a content item to the content item. For example, if a video game review website does not include advertisements, advertisements of a specified type or a threshold number of advertisements, proxy 510 may independently retrieve and add additional content (e.g., advertisements) to the website. FIG. 7 illustrates an example method for independently retrieving and adding additional content to a content item. In step 700, a proxy device or component may determine whether a content item includes content of a specified type or number. The content item may be evaluated for content by the proxy device prior to reaching a requesting application. If the content item does not include the specified type or amount of content, the proxy device may request additional content in step 705. The request may include information or parameters specific to the user or client. In step 710, the proxy may further modify the content item to specify the inclusion of the additional content in the content item. For example, in an HTML environment, additional tags may be added in the web page code to specify inclusion and placement of the additional content within the page. In step 715, the proxy may receive the requested additional content. The content item may then be transmitted to a requesting application along with the additional content in step 720. Alternatively, the content item may be provided to the application separately from the additional content.

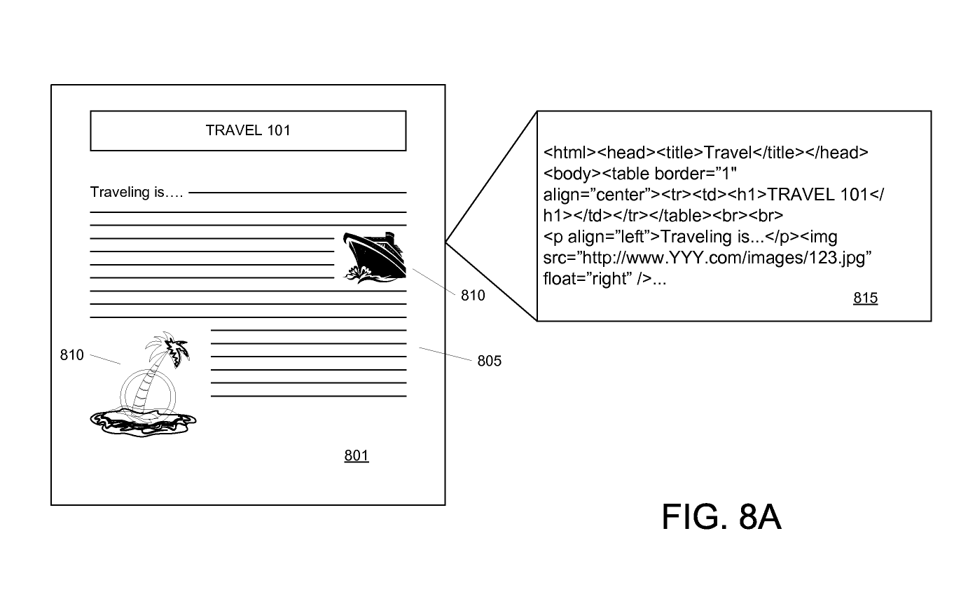

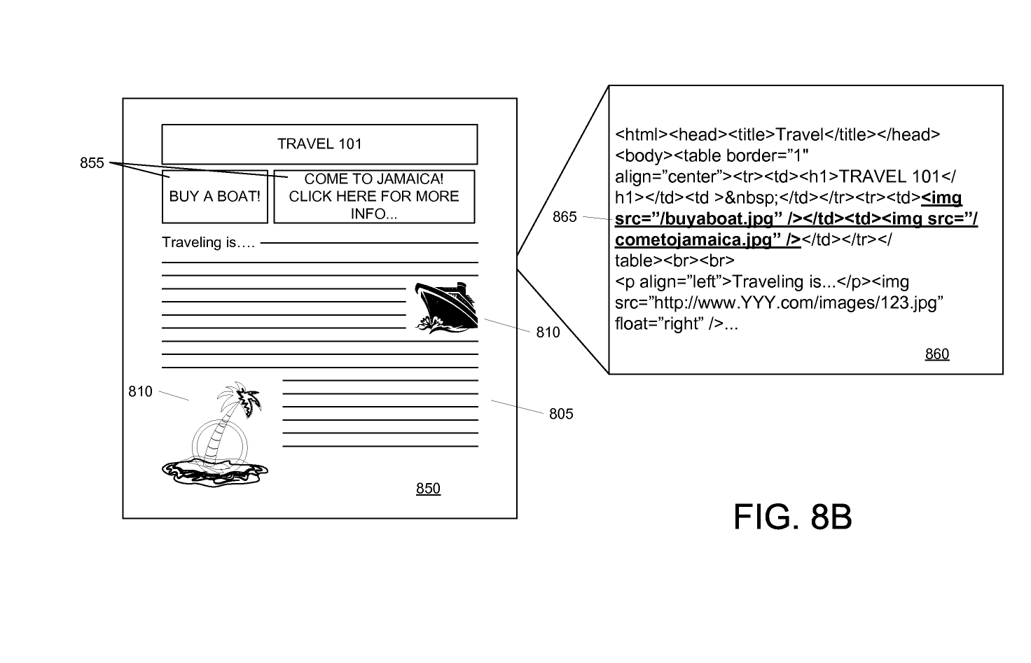

FIG. 8A illustrates an original web page 801 prior to modification by a proxy. The web page includes text 805 and images 810. No advertisements are included in the original web page 801. Web page code 815 defines the content of page 801 as well as the locations of text 805 and images 810. Referring to FIG. 8B, upon processing by a proxy, modified web page 850 includes not only text 805 and images 810, but also advertisements 855. Notably, modified page code 860 includes additional tags 865 (added by the proxy) defining the placement and inclusion of advertisements 855.

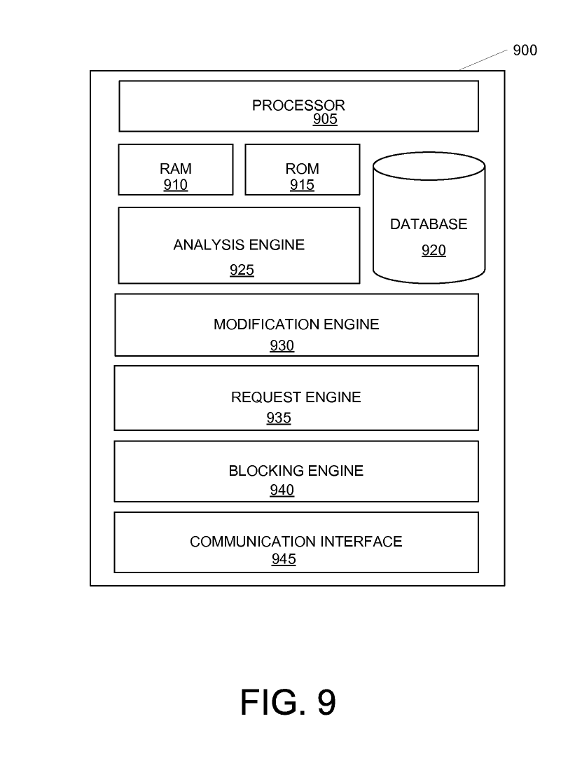

FIG. 9 illustrates components of a proxy apparatus configured to analyze, modify, block or otherwise act on content items. Proxy apparatus 900 includes a processor 905, memory including RAM 910, ROM 915 and database 920, analysis engine 925, modification engine 930, request engine 935, blocking engine 940 and communication interface 945. RAM 910, ROM 915 and database 920 may be configured to store various computer readable instructions that are executed by processor 905 including any or all of the method steps shown in the flowcharts herein. Analysis engine 925 may be configured to determine and evaluate the content of content items. Analysis engine 925 may, for example, parse web page code to identify types of content included in the web page. Modification engine 930 is generally configured to modify content items such as web pages. In one example, modification engine 930 may modify web page code to include additional content such as images, advertisements, text and the like. Request engine 935 may be used and configured to retrieve content including content items and content embedded or included therein (e.g., an image, audio track, video clip, advertisement). In one or more arrangements, content added by modification engine 930 may be retrieved or requested by request engine 935. Request engine 935 may further modify requests to include or remove certain request parameters or information. Blocking engine 940, on the other hand, may be configured to block content items. For example, blocking engine 940 may instruct modification engine 930 to remove content if the content violates restrictions or limitations placed on a user or underlying device. In another example, blocking engine 940 may instruct request engine 935 to ignore or delete certain requests.

In one or more configurations, database 920 may store rules for modifying and redirecting content requests and content. Database 920 and the rules stored therein may be updated in a variety of ways including based on user specifications entered through a client device, receiving updates periodically or aperiodically from a service provider or other server associated with the control of the proxy and the like. In one example, a device owner's parent or guardian may specify a code for changing rules stored in database 920. Thus, the device owner might not be able to change the rules. The database 920 and the rules stored therein may, for example, be transferred over-the-air, supplied in a removable memory medium, and/or the like to the client device.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, field-programmable gate arrays (FPGAS), controllers, application-specific integrated circuits (ASICS), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read-only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

I claim:

1. A method comprising:
determining, at a client, whether a content request should be modified;
in response to determining that the content request should be modified, modifying, at the client, the content request by adding or removing a request parameter prior to transmitting the content request to a content server; and
transmitting the modified content request to the content server.

2. The method of claim 1, further comprising receiving the content request from an application configured to run on the client and wherein modifying the content request is performed by a client-side proxy different from the application.

3. The method of claim 1, wherein the parameter is a geographic location of the client.

4. The method of claim 1, wherein the parameter is a user preference of a user associated with the client.

5. The method of claim 1, wherein the client is a mobile communication device.

6. The method of claim 1, wherein the content includes an advertisement.

7. The method of claim 1, further comprising:
receiving the requested content from the content server;
modifying a second content to include the received content, wherein the second content is requested by an application; and
providing the modified second content to the application.

8. The method of claim 7, wherein the requested content is an advertisement and the second content is a content page.

9. The method of claim 8, wherein the second content, prior to modification, does not include advertisements.

10. The method of claim 1, further comprising:
receiving the requested content; and
modifying at least a portion of the requested content.

11. One or more computer readable media storing computer readable instructions that, when executed, cause a processor to perform a method comprising:
determining, at a client, whether a content request should be modified;
in response to determining that the content request should be modified, modifying, at the client, the content request by adding or removing a request parameter prior to transmitting the content request to a content server; and
transmitting the modified content request to the content server.

12. The one or more computer readable media of claim 11, further comprising instructions for receiving the content request from an application configured to run on the client and wherein modifying the content request is performed by a client-side proxy different from the application.

13. The one or more computer readable media of claim 11, wherein the parameter is a geographic location of the client.

14. The one or more computer readable media of claim 11, wherein the parameter is a user preference of a user associated with the client.

15. The one or more computer readable media of claim 11, wherein the requested content is a web page.

16. The one or more computer readable media of claim 11, wherein the content includes an advertisement.

17. The one or more computer readable media of claim 11, further comprising instructions for:
receiving the requested content from the content server;
modifying a second content to include the received content, wherein the second content is requested by an application; and
providing the modified second content to the application.

18. An apparatus comprising:
a processor; and
memory having stored therein computer readable instructions that, when executed, cause the processor to perform a method comprising:
determining, at the apparatus, whether a content request should be modified;
in response to determining that the content request should be modified, modifying, at the client, the content request by adding or removing a request parameter prior to transmitting the content request to a content server; and
transmitting the modified content request to the content server.

19. The apparatus of claim 18, wherein the apparatus is local to a client requesting the content.

20. The apparatus of claim 19, wherein the apparatus is included in the client.

21. The apparatus of claim 20, wherein the memory further stores instructions for:
receiving the requested content from the content server;
modifying a second content to include the received content, wherein the second content is requested by an application; and
providing the modified second content to the application.

22. The apparatus of claim 18, wherein the parameter includes a user preference of a user associated with the apparatus.

23. The apparatus of claim 18, wherein the apparatus is a mobile communication device.

24. The apparatus of claim 18, wherein the content includes an advertisement.

25. A method comprising:
receiving, at a proxy, content from a content server, wherein the content is requested by an application running on a client, wherein the proxy is local to the client;
modifying, at the proxy, the received content prior to providing the modified content to a requesting application; and
providing the modified content to the requesting application.

26. The method of claim 25, wherein modifying the received content includes inserting a content item into the received content.

27. The method of claim 26, wherein the content item is an advertisement.

28. The method of claim 25, wherein modifying the received content includes modifying hypertext markup language (HTML) code of the received content.

29. One or more computer readable media storing computer readable instructions that, when executed, cause a processor to perform a method comprising:
receiving, at a proxy, content from a content server, wherein the content is requested by an application running on a client, wherein the proxy is local to the client;
modifying, at the proxy, the received content prior to providing the modified content to a requesting application; and
providing the modified content to the requesting application.

30. The one or more computer readable media of claim 29, wherein modifying the received content includes inserting a content item into the received content.

31. The one or more computer readable media of claim 29, wherein the content item is an advertisement.

32. An apparatus comprising:
a processor; and
memory storing computer readable instructions that, when executed, cause the apparatus to perform a method comprising:
receiving, at the apparatus, content from a content server, wherein the content is requested by an application running on a client and wherein the apparatus is local to the client;
modifying, at the apparatus, the received content prior to providing the modified content to a requesting application; and
providing the modified content to the requesting application.

33. The apparatus of claim 32, wherein the content item is an advertisement.

34. The apparatus of claim 32, wherein modifying the received content includes removing at least one content item from the received content.
